(19) United States
(12) Patent Application Publication
(10) Pub. No.: US 2005/0078083 A1
(43) Pub. Date: Apr. 14, 2005

(54) Input device, system and method for controlling objects that can be displayed on a display

(76) Inventors: Andreas Simon, Bonn (DE); Bernd Frohlich, Hannover (DE)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/961,462

(22) Filed: Oct. 8, 2004

(30) Foreign Application Priority Data
Apr. 10, 2002 (DE) DE 102 15 797.9
Oct. 10, 2002 (DE) DE 102 47 287.4
Apr. 9, 2003 (WO) PCT/EP03/03684

(51) Int. Cl. G09G 5/00; F16H 37/02

(52) U.S. Cl. 345/156

(57) ABSTRACT

The invention relates to an input device, a system and method especially for controlling an object that can be displayed on a display. According to the invention, forces and torque acting upon an actuating member are detected and evaluated in terms of their amount and absolute direction, thereby allowing for an easy handling of the device and system even in complicated control situations.

### CROSS REFERENCE TO RELATED APPLICATION

This application claims priority to International Patent WO 03/085506 filed Oct. 16, 2003, which is incorporated herein by reference.

### BACKGROUND OF THE INVENTION

The present invention pertains generally to manually operable input devices for generating control signals or for controlling. In particular, the input devices serve to control computer-animated or computer-generated illustrations, games, objects or the like, preferably and particularly, graphic objects on a display such as a video screen or the like. Thus, input devices in the above-referenced sense are, for instance, so-called mice.

The present invention is primarily aimed at three-dimensional applications. Therefore, the input device is preferably freely movable, i.e., in all three directions in space. The input device then has three translational degrees of freedom (three axes) as well as three rotational degrees of freedom (three additional axes). These degrees of freedom are also referred to simply as axes below.

WO 00/14676 A1, which constitutes the starting point of the present invention, discloses an input device with a cube-shaped housing and rod-shaped actuating members that project centered at their centers from the side surfaces of the housing along the orthogonal axes of space. The pairwise opposing actuating members can be actuated along their shared direction of extension, optionally against the force of a restoring spring, and serve to control a translational displacement in one direction, i.e., to control one axis. By longitudinal displacement of the actuating members as a whole, a translational displacement of a displayed object can be controlled in three axes.

In the known input device, moreover, the rod-shaped actuating members or sleeves associated with them can be rotated in order to control a rotational motion of the displayed object.

Consequently, each actuating member is provided to control two axes. For complex applications and particularly for controlling six axes and more, therefore, a plurality of actuating members are necessary, whereby the operation of the input device is rendered more difficult and, in particular, intuitive operation is not possible.

The known input device additionally comprises a position-recognition sensor system for detecting the orientation and/or position of the housing. The sensor system generates an appropriate control signal for the display device to orient the object on the display device corresponding to the orientation and position of the housing. Additional or other processing of the position signals is not provided.

EP 0 979 990 A2 discloses a stationary force-torque sensor with a cap-shaped actuating member. The actuating member can be moved or actuated in six axes, and the sensor can detect this actuation and issue corresponding control signals for control purposes. This sensor is usually held by a stationary part, such as a mounting plate, or by a quasi-stationary part, such as a robot arm or the like.

The present invention is based on the problem of specifying an input device, a system and a method of generating control signals, particularly for controlling a computer or at least one object that can be displayed on a display, wherein a simple and, particularly, an intuitive handling of the input device is made possible and, in particular, it is also possible for complex processes to be controlled without the operator having to regrip.

### SUMMARY

One form of the present invention is an actuating member with an associated actuation sensor for detecting the manual actuation force and torque for at least three axes, preferably four or six axes, and additionally to employ a position sensor for detecting the orientation of the input device in order to determine the absolute (i.e., actual) direction of the actuation forces and/or torque acting on the actuating member. Additionally, the magnitude of the actuation forces or torque is then detected. Accordingly, control signals can be provided that enable manipulation or control, taking into account the absolute direction and acting on objects displayed on a display such as a video screen.

An essential aspect is therefore to detect actuation forces/torque and to combine them with the absolute actuation direction by taking into account the position signals provided by the position sensor, in order to enable a largely realistic control, more particularly, a manipulation of a graphic object on a screen, for instance, or in some other type of projection.

The solution as proposed permits a relatively simple and, more particularly, a largely intuitive control of, preferably, a graphic object or the like on a video screen or other display.

According to a particularly preferred configuration, the input device comprises at least two actuating members for controlling at least three axes each. With relatively simple handling, this enables, for instance, the independent controlling of two objects, without regripping by the user at the input device being necessary.

A particularly preferred configuration in ergonomic respects is distinguished by the fact that two actuating members and a central section of the input device arranged between them have an at least substantially similar cross section or diameter and are arranged one behind the other. The actuating members and the central section are preferably constructed to be disk- or ring-shaped and have a shared axis of symmetry. Preferably the input device as a whole has an at least substantially rod-like or cylindrical shape or outside contour.

According to one embodiment variant, however, the actuating members can also vary from one another or from the central section in diameter, cross section, outer contour, color, material and/or in surface type or texture, particularly in order to permit them to be distinguished.

### BRIEF DESCRIPTION OF THE DRAWINGS

Additional advantages, features, characteristics and aspects of the present invention result from the description below of a preferred embodiment on the basis of the drawing. It shows:

FIG. 1, a schematic side view of an input device as proposed;

FIG. 2, a schematic side view of the input device of FIG. 1; and

FIG. 3, a schematic representation of a system as proposed with the input device, a display and a computer.

### DESCRIPTION OF THE SELECTED EMBODIMENT

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

In the figures, the same reference numbers are used for identical or similar parts, with corresponding or comparable advantages being achieved, even if a repeated description is omitted, in part for reasons of simplification.

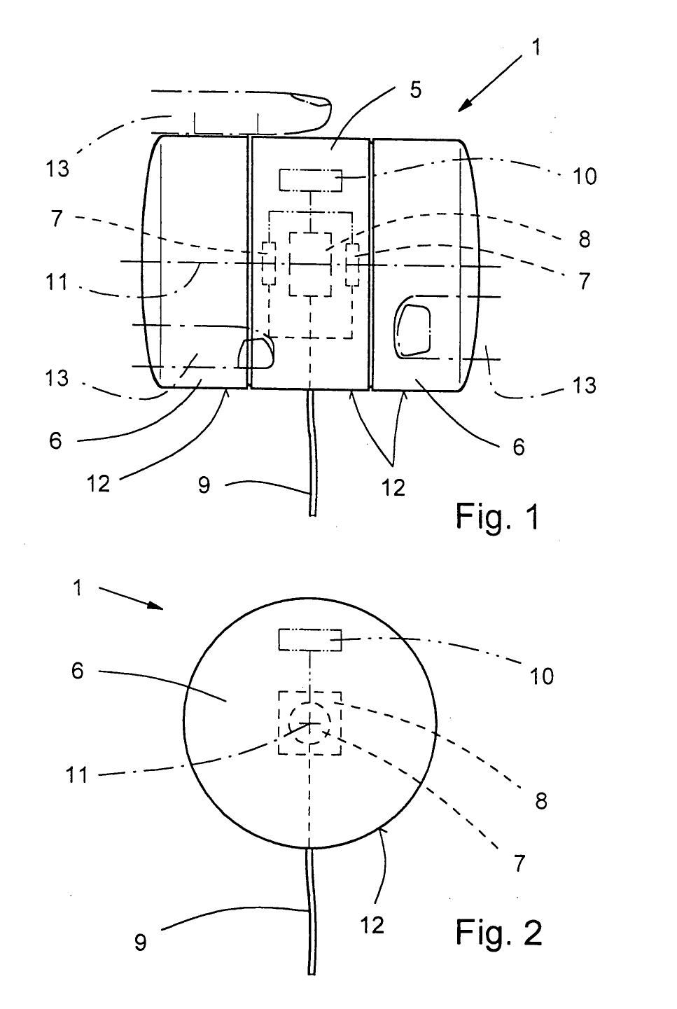

FIG. 1 shows in schematic side view a portable input device 1 as proposed.

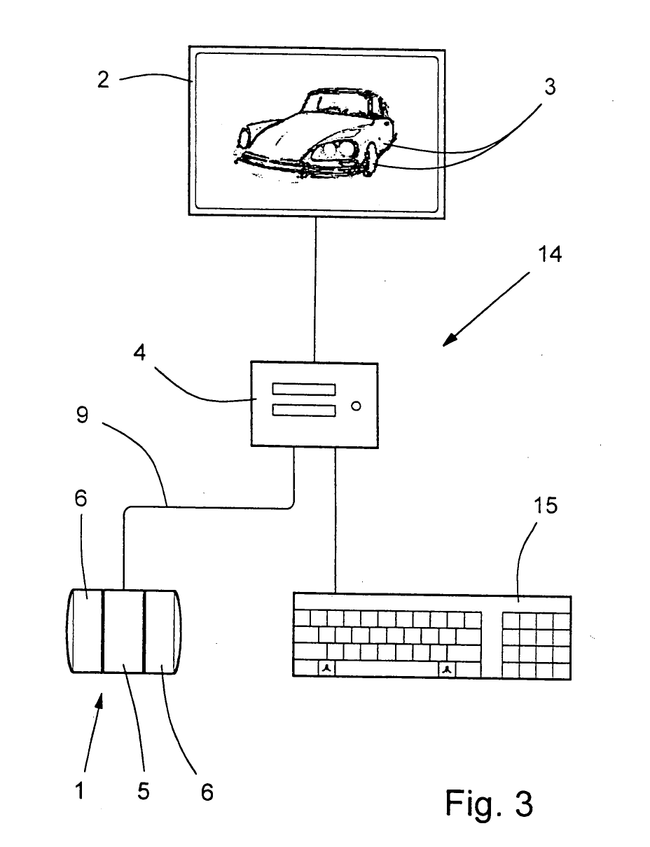

In the display example of FIG. 3, input device 1 serves to control at least one object 3, here a graphical one, preferably several objects 3, displayed on a display 2. The display 2 is, in particular, a video screen or the like. Any other type of projection could also be considered, however.

In the display example, input device 1 and display 2 are associated with, more particularly, connected to, a computer 4 that exercises control functions. The connection can be accomplished via a cable, for instance, or particularly for the one to input device 1, wirelessly by radio or light.

According to FIG. 1, input device 1 comprises a central section 5, as well as at least one actuating member 6, here two actuating members 6.

Each actuating member 6 can be moved or actuated in at least three axes, preferably in four axes and, in the display example, in six axes relative to central section 5.

In the display example, actuating members 6 are elastically positioned or held directly or indirectly at central section 5.

The actuation of an actuating member 6 can be detected by an associated actuation sensor 7, as indicated in FIG. 1. The term “sensor” should be understood here in a broad sense to the effect that it pertains to a suitable detection or sensor system, particularly an electronic system, that enables a sufficiently accurate detection of an actuation of the associated actuating element 6.

For clarification, it can be pointed out that actuating members 6 in the display example can preferably be displaced in all three translational directions in space and tilted about these axes, thus enabling actuation in six axes. In order to permit such a detection, the actuation sensor 7 associated with each actuating member 6, or the unit formed of an actuating member 6 and the associated actuation sensor 7, is preferably constructed according to EP 0 979 990 A2. This publication is herewith incorporated in its entirety.

As needed, actuating member 6 and the associated actuation sensor 7 can also be constructed or realized in some other suitable way.

According to another aspect, also realizable independently, at least one actuating member 6 can additionally be constructed to be deformable itself in places, deformations being detectable by the associated actuation sensor 7 to generate corresponding actuation signals, particularly in the nature of so-called soft keys. This additional functionality can be employed to control additional functions, other objects 3 or the like.

In addition or alternatively, input device 1 can also comprise other actuating members, switches or the like.

The two actuating members 6 can be used in particular for controlling different functions and/or objects 3. Accordingly, the actuating members 6 and/or their associated actuation sensors 7 can have different characteristics, evaluations and so on. For instance, the two actuating members 6 with different forces or spring hardnesses that are path-dependent and/or fedback or active (i.e., dependent on the controlled object 3, for example, its speed) can be movable relative to central section 5, in particular, tiltable or rotatable and/or displaceable.

In the display example, each actuating member 6 is associated with its separate or individual actuation sensor 7. Depending on the design, however, only one single sensor 7 may be provided for detecting the actuation of both actuating members 6.

The actuation sensors 7 are arranged in the central section 5 in the display example. This is not absolutely necessary. Rather, the arrangement can be adapted to the respective technical conditions.

The actuation sensors 7 are preferably constructed such that the actuating forces and torque acting on actuating members 6 during actuation are detectable, more specifically, in regard to magnitude and direction. In particular, then, these are force-torque sensors. Actuation sensors 7 can generate or emit corresponding control signals.

Associated with the input device 1 as proposed is a position sensor 8 for detecting or determining at least the orientation and, in particular, also the position of input device 1 and generating corresponding position signals. In the display example, position sensor 8 is likewise arranged in input device 1, more particularly, integrated into or installed in central section 5, as indicated in FIG. 1.

Alternatively, position sensor 8 can also be arranged outside input device 1 and constituted, for example, by suitable cameras, other tracking systems or the like.

According to another embodiment variant, position sensor 8 can also be constituted by an orientation sensor and a position sensor.

Position detection can be source-bound or source-free. Correspondingly, position sensor 8 then cooperates, if desired, with external sources.

The signals provided by sensors 7, 8 can be converted, processed and/or evaluated, as needed, in input device 1 and/or in the associated computer 4 or in some other device. The signals can then be emitted via, for example, cable 9 indicated in FIG. 1 to computer 4 and/or display 2.

Alternatively, to cite one example, wireless transmission of signals can also be provided via, for instance, an evaluation and/or transmission unit 10, as indicated in FIG. 1.

The evaluation or usage of the signals provided or the measured values acquired by sensors 7, 8 will be discussed in more detail later.

Actuating members 6 and central section 5 preferably have an at least substantially similar cross section or diameter and are arranged one behind the other, as shown in FIG. 1.

In particular, input device 1 is formed at least substantially in a rod shape or, as indicated in FIGS. 1 and 2, cylindrically. In this case actuating members 6 and central section 5 are preferably in a disk or ring shape and have a shared axis of symmetry 11. Other geometrical formations and/or arrangements are possible, however.

Actuating members 6 are arranged on opposing sides of central section 5 in the display example. Depending on the construction of the input device 1, a gap can be formed between central section 5 and each actuating member 6. Preferably, however, the adjoining parts or edges overlap at least partially in order to at least largely prevent intrusion of dirt or the like. If needed, an elastic intermediate piece or the like for filling out or bridging the aforementioned gap can also be provided.

Actuating members 6 are formed at least substantially in a cap shape in the display example. In particular, actuating members 6 and central section 5 form outer contact surface or peripheral surfaces 12 for radial contact of fingers 13 for operating input device 1, as illustrated by way of example in FIG. 1, wherein a user is not shown, however.

The longitudinal extension of fingers 13 runs in holding/operation preferably substantially parallel to axis of symmetry 11 of input device 1. When input device 1 is held between two facing hands of an operator (not shown) fingers 13 from each side can reach over one actuating member 6 and central section 5. By slight radial opening and closing of fingers 13 in the area of central section 5, the relative movability of an actuating member 6 with respect to central section 5 can be released or blocked in keeping with requirements. Accordingly, very diverse operation of input device 1 without regripping is enabled.

It may also suffice, however, merely to hold or support an actuating member 6 with one hand or the fingers 13 of one hand.

The input device 1 as proposed allows in an ergonomic sense a very simple operation or handling and, depending on the programming or further processing of the generated signals, an intuitive one as well.

For the further processing of the signals provided or the values acquired by actuation sensors 7 and position sensor 8, the forces and/or torque acting on actuating members 6 are preferably determined in magnitude and direction, wherein by taking into account the position signals provided by position sensor 8, the actual or desired direction of the forces and torque, i.e., the absolute direction in particular relative to the coordinate system of the earth or, optionally, of the graphical space of the displayed object 3, can be determined by taking into account the current position of input device 1.

The absolute actuation forces or torque are then employed for controlling or manipulating at least one object 3, as indicated in FIG. 3. Here, for the sake of example, the displayed auto is a first object 3 that is controlled or manipulated by means of one actuating member 6. The car's tire constitutes a second object 3 that can then be controlled or manipulated with the second actuating member 6. Thus it is possible to simulate the mounting of a tire with input device 1 wherein, for instance, the car is raised and the tire is properly put into place.

An additional example of a computer-controlled or computer-simulated two-body problem that can be handled especially easily with the input device 1 as proposed is a bottle with a stopper, more particularly, a screw cap, which is put into place, specifically, screwed on while the bottle is appropriately held in place.

Input device 1, however, is also usable for controlling individual objects 3, for instance, for the deformation of a hose or a curve.

FIG. 3 shows a system 14 as proposed which comprises in the display example the input device 1 as proposed, the display 2 for objects 3 and the associated computer 4. The computer 4 can be controlled, not only by input device 1, but also in the usual manner by a keyboard 15, as indicated in FIG. 3.

In place of the display 2 in the form of a video screen or the like that is indicated in the system 14 as proposed, some other projection or generation of graphic objects 3 can of course also be provided.

Input device 1 as proposed is not limited to the control or manipulation of objects 3 in the above-described sense, however. Rather, input device 1 can be universally employed for control functions for games, for instance, or as a musical instrument or the like. In general, input device 1 can be employed for any type of technical control.

In particular, up to twelve axes can be controlled all together by the two actuating members 6.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. Apparatus comprising an input device for controlling at least one of a computer and at least one object that can be displayed on a display, with a central section, at least one manually actuatable actuating member, an actuation sensor for generating control signals upon actuation of said actuating member and that is associated with actuating member and a position sensor for determining the orientation and, in particular, the position of said input device or of central section and for generating corresponding position signals, characterized in that said actuating member can be actuated in at least three axes relative to said central section and in that forces and/or torque acting during actuation on said actuating member can be detected according to their magnitude and direction by said actuation sensor and corresponding control signals can be emitted, the absolute direction of the forces or torque being determinable by means of the position signals provided by said position sensor.

2. Apparatus according to claim 1, characterized in that said actuating member can be moved or actuated in at least four axes, preferably in six axes, relative to said central section and in that forces and torque acting during actuation on said actuating member can be detected in magnitude and direction by said actuation sensor and corresponding control signals can be emitted.

3. Apparatus according to claim 1 characterized in that said actuating member can be actuated against a fedback and/or path-dependent force, in particular, a spring force.

4. Apparatus according to claim 1, characterized in that said input device has two said actuating members and associated actuation sensors and/or in that said input device is portable.

5. Apparatus according to claim 4, characterized in that said actuating members are arranged on opposite sides of said central section.

6. Apparatus according to claim 4, characterized in that said actuating members can be actuated independently of one another and, in particular, have the same functionality.

7. Apparatus according to claim 3, characterized in that said actuating members can be actuated against different fedback and/or path-dependent forces, in particular, different spring hardnesses.

8. Apparatus according to claim 1 further comprising a display and a computer wherein, to control at least one object that can be displayed on said display, said input device is connected to at least one of said computer and said display characterized in that actuation forces and/or torque acting on said actuating member can be evaluated by magnitude and direction for manipulating or controlling said object.

9. Apparatus according to claim 8, characterized in that, by evaluation of the position signals, forces and/or torque, acting preferably in three or four axes, particularly in six axes, on said actuating member of said input device during actuation, can be determined with respect to their absolute direction, more particularly their magnitude and/or point of attack, to said computer or determined by it.

10. Apparatus according to claim 9, characterized in that two objects can be controlled independently of each other or relative to each other by means of two separate said actuating members of said input device.

11. A method for controlling at least one object that can be displayed on a display by means of a manually actuatable input device freely movable in space and of an associated computer, wherein the magnitude and direction of forces and torque acting on an said actuating member of input device, as well as the orientation of input device, are detected and evaluated as corresponding manipulations acting on said object, taking into account the absolute direction.

12. A method according to claim 11, characterized in that two objects are controlled independently of each other by means of two separate said actuating members of input device.
